(19) United States
(12) Patent Application Publication
(10) Pub. No.: US 2011/0022771 A1
(43) Pub. Date: Jan. 27, 2011

(54) SYSTEM AND METHOD FOR DISPLAYING ALARM NOTIFICATIONS ON AN ON-SCREEN DISPLAY

(75) Inventor: Robert Foerster, Ravenna, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Video Products, Inc., Aurora, OH (US)

(21) Appl. No.: 12/508,002

(22) Filed: Jul. 23, 2009

(51) Int. Cl. G06F 13/00; G06F 9/46

(52) U.S. Cl. 710/316; 719/318

(57) ABSTRACT

A Keyboard, Video, Mouse (KVM) switch that includes one or more input ports to receive events, notifications and/or alarms generated by an external device. The KVM switch receives the events, notification and/or alarms in the form of an external signal. The KVM switch processes the external signals and compares the received external signal to one or more reference signals to identify an event that corresponds to the received external signal. The KVM switch then generates an announcement for display on one or more displays associated at least one user station coupled to the KVM switch.

### TECHNICAL FIELD OF THE INVENTION

The present invention relates generally to a Keyboard, Video, Mouse (KVM) switch that includes one or more input ports to receive events, alarms and/or notifications, the KVM switch interprets the received event, alarm and/or notification and generates an announcement for display one or one or more displays coupled to the KVM switch.

### DESCRIPTION OF THE RELATED ART

A KVM switch represents a class of switching devices designed to provide a user the ability to operate, control, and monitor multiple computers from a single keyboard, monitor, and mouse. A system incorporating a KVM switch (a KVM system) allows the user to select a host computer to operate, monitor and control from the user's input station, terminal or workstation. The user may select the host computer from an interface displayed on the user's monitor or from controls located directly on the KVM switch. Generally, a KVM system works by allowing a user to select a host computer to monitor and control from the terminal or workstation accessible to the user. The KVM system may be located locally to the user or the user may gain access to the KVM system remotely. A KVM system is generally capable of switching the video signals of the selected host computer to the user's monitor so that the user may view the host's video signal from the user's monitor. A KVM system is also capable of routing the user's keyboard and mouse signals to the respective ports of the selected host computer. From the host computer's perspective, it appears as if the user's keyboard and mouse are directly attached to the host.

### SUMMARY OF THE INVENTION

The present invention is directed to a Keyboard, Video, Mouse (KVM) switch that includes one or more input ports to receive events, alarms and/or notifications, the KVM switch interprets the received event, alarm and/or notification and generates an announcement for display one or one or more displays coupled to the KVM switch.

One aspect of the invention relates to a keyboard, video and mouse (KVM) switch, the KVM switch including: a housing; switching circuitry contained at least partially within the housing, wherein the switching circuitry is selectively operable to couple one or more user stations to one or more host processors; a plurality of user station ports for communicatively coupling one or more user stations to the switching circuitry, wherein at least one user station includes a keyboard port for coupling to an associated keyboard, a video display port for coupling to an associated video display and a mouse port for coupling to an associated mouse; a plurality of host processor ports for communicatively coupling one or more host processors to the switching circuitry; and one or more input ports for receiving an external signal from an associated device; a controller housed at least partially within the housing, wherein the controller is coupled to the switching circuitry and at least one of the input ports, wherein the controller processes the received external signal received at the one or more input ports and compares the received external signal to one or more reference signals to identify an event that corresponds to the received external signal and the controller generates an announcement for display on one or more of the displays associated with one or more user stations.

Another aspect of the invention relates to a method of providing an announcement of an occurrence of an environmental event associated with one or more components of a keyboard, video and mouse (KVM) system to users of the KVM system, the method including: receiving an external signal from an associated device at a KVM switch; comparing the received external signal to one or more reference signals stored in a memory coupled to the KVM switch to identify an event that corresponds to the received external signal at the KVM switch; generating an announcement that corresponds to the received external signal, and displaying the announcement on one or more displays coupled to the KVM switch.

Another aspect of the invention relates to a system for providing on-screen announcements to users of a keyboard, video and mouse (KVM) system upon the occurrence of an event, notification and/or alarm, the system including: an external device for generating an output signal upon an occurrence of an event; a KVM switch having a plurality of ports for coupling one or more user stations to one or more host computers, wherein the KVM switch includes a one or more input ports for receiving the output signal generated from the external device, wherein the KVM switch includes a controller that processes the received output signal from the external device and compares the received output signal to one or more reference signals to identify an event that corresponds to the received external signal and the controller generates an announcement for display on a display associated with one or more user stations.

Other systems, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a block functional diagram of an exemplary keyboard, video and mouse (KVM) switch in accordance with aspects of the present invention.

FIG. 2 is an exemplary KVM system in accordance with aspects of the present invention.

FIG. 3 is another exemplary KVM system in accordance with aspects of the present invention.

FIG. 4 is an exemplary method in accordance with aspects of the present invention.

FIGS. 5A and 5B are exemplary on-screen notifications in accordance with aspects of the present invention.

### DETAILED DESCRIPTION OF THE INVENTION

Aspects of the present invention relate to a Keyboard, Video, Mouse (KVM) switch that includes one or more input ports to receive events, alarms and/or notifications. The KVM switch interprets the received event, alarm and/or notification and generates an announcement for display one or one or more video monitors coupled to the KVM switch. The system and method disclosed herein provides a fail safe notification method that does not couple receiving the announcement to any single computer. For example, the KVM switch may receive a signal indicating the occurrence of an event, alarm and/or notification. The KVM switch may interpret the signal and generate a corresponding announcement for display on one or more computer displays coupled to the KVM switch to notify the user of the occurrence of the event, alarm and/or notification.

The events, alarms and/or notifications may be generated by any external device or software that is capable of generating such signals upon the occurrence of an event, alarm or notification. For example, the events, alarms and/or notifications may be generated by one or more environmental monitoring devices, by one or more software applications (e.g., an electronic calendar application, monitoring software, maintenance schedules, authentication and auditing applications, etc).

The events, alarms and/or notifications may be signaled from the external device to the KVM switch by any method. For example, the events, alarms and/or notifications may be signaled to the KVM switch by short message service (SMS), simple network management protocol (SNMP), e-mail, proprietary signaling protocols, serial signaling, parallel signaling, etc. The KVM switch may utilize one or more input ports to receive a signal corresponding to the event, alarm and/or notification. Suitable input ports include for example a serial port, an Ethernet port, a wireless Ethernet port, a wireless adapter, or other suitable means to receive the alarms, events and/or notifications.

The received signals may be compared to one or more reference signals to identify the corresponding event, alarm and/or notification. Once the corresponding event, alarm and/or notification is identified, the KVM switch may cause an appropriate announcement to be generated and displayed on the screen of one or more video monitors coupled to the KVM system. The announcement may be displayed over the contents displayed on the video monitor, so as to draw the user's attention to the announcement. An audible indication may also be triggered to correspond with displaying the announcement in order to further draw the user's attention to the announcement. In another embodiment, the announcement may also include a conspicuous graphical element displayed within the content of the user's display. Such announcement will generally be provided with graphical effects to draw the user's attention to the announcement.

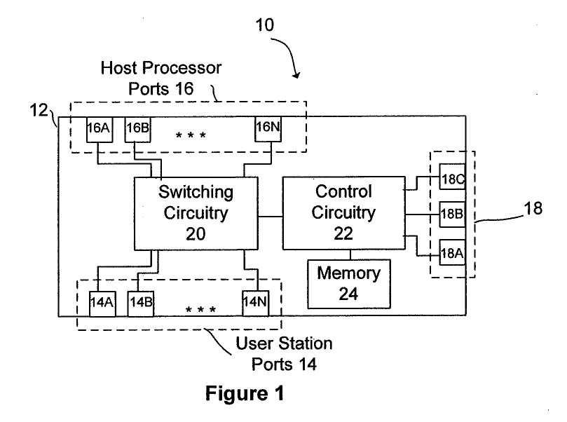

Referring to FIG. 1, an exemplary KVM switch 10 in accordance with aspects of the present invention is illustrated. The KVM switch 10 includes a housing 12. The housing 12 generally encloses the KVM switch 10 and includes a variety of ports to allow the exchange of signals between devices connected to the KVM switch.

The KVM switch 10 includes one or more ports 14 (e.g., 14A, 14B, . . . , 14N) for coupling the KVM switch 10 to one or more user stations. The KVM switch further includes one or more ports 16 (e.g., 16A, 16B, . . . , 16N) for coupling the KVM switch 10 to one or more host processors. The KVM switch 10 further includes one or more ports 18 (e.g., 18A, 18B, . . . 18N) for coupling the KVM switch 10 to one or more devices and/or software applications, for example. One of ordinary skill will appreciate that the alphabet characters may refer to any number of ports 14, 16 and or 18. The alphabet characters are simply used to designate that each of the ports may include one or more ports.

The KVM switch 10 includes switching circuitry 20 contained at least partially within the housing 12. The switching circuitry 20 is selectively operable to logically couple one or more user stations to one or more host processors through the respective ports (e.g., ports 14, 16). The KVM switch 10 includes a control circuit 22 (also referred to herein as controller). The control circuit 22 may be housed at least partially within the housing 12. The control circuitry 22 is coupled to the switching circuitry 18 and at least input port 18 (e.g., ports 18A, 18B, 18C).

The control circuitry 22 may utilize executable code stored in an internal memory of the control circuitry 22 or may access logic and/or executable code stored in a separate memory 24, which may be coupled to the control circuitry 22. The control circuitry 22 is configured to carry out overall control of the functions and operations of the KVM switch 10. The control circuitry 22 may include a processing device (not shown), such as a CPU, microcontroller or microprocessor. The control circuitry 22 executes code stored in a memory (not shown) within the control circuitry 22 and/or in a separate memory, such as memory 24, in order to carry out the operation of the KVM switch 10 described herein. The memory 24 may be, for example, a buffer, a flash memory, a hard drive, a removable media, a volatile memory and/or a non-volatile memory.

The control circuitry 22 may process the received external signals received at the one or more input ports (e.g., port 18) and compares the received external signal to one or more reference signals in order to identify an event, alarm and/or notification that corresponds to the received external signal. The control circuit 22 also may generate an announcement for display on the one or more video monitors coupled to the KVM switch 10 in order to make the user aware of the occurrence of an event, alarm and/or notification generated by the external device and/or an application program.

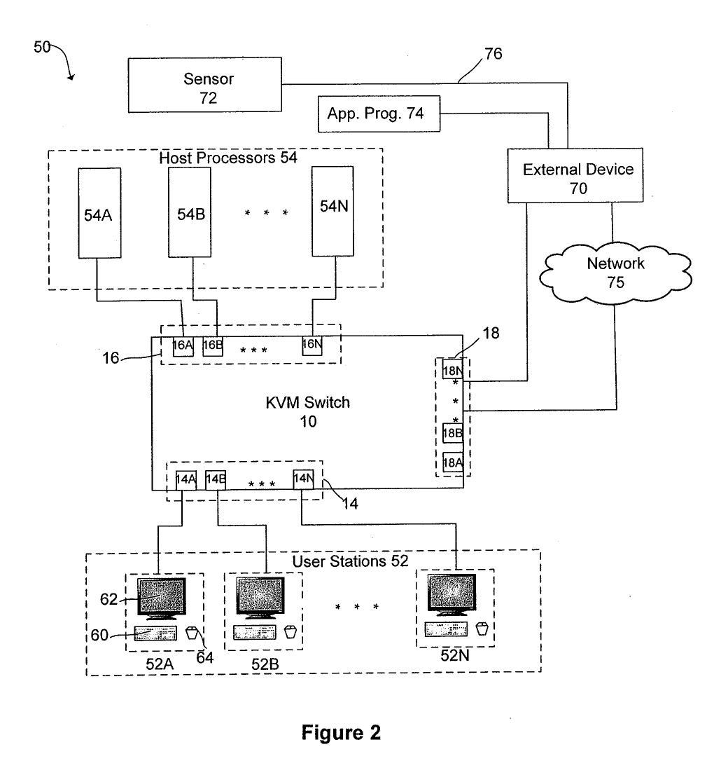

Referring to FIG. 2, an exemplary KVM system 50 is illustrated. The KVM system 50 includes KVM switch 10, one or more user stations 52 coupled to the KVM switch 10 through one or more ports 14 (e.g., ports 14A, 14B to 14N), respectively. The term “user station” refers to interfaces and devices, which are coupled to the KVM switch 10, that are utilized by users to access information and/or content from one or more host processors 54, for example.

Referring to FIG. 2, the user stations 52 (e.g., user stations 52A, 52B to 52N) generally include a keyboard 60, a video monitor 62, and a mouse 64. As used herein, the term “keyboard” includes any conventional computer keyboard as well as any keypad entry device. Likewise, the term “mouse” includes any conventional computer mouse, a trackball, a thumbwheel, etc. In certain limited circumstances, a video monitor 62 may also be referred to as a user input device (e.g., when the computer monitor is a touch screen device). While the user station 10 has been described as including three components (a keyboard, video monitor, and mouse), one of ordinary skill in the art will appreciate that some user stations may include one component, or a combination of components.

Each of the one or more ports 14 includes a plurality of ports for connecting various user stations 54 to the KVM switch 10, as described above. For example, each of the one or more ports 14 (e.g., ports 14A, 14B to 14N) may include a keyboard port for coupling the KVM switch 10 to an associated keyboard, a video display port for coupling the KVM switch 10 to an associated video display and a mouse port for coupling the KVM switch 10 to an associated mouse for a user station. In general, each of the ports 14 includes separate keyboard, video, and mouse ports for each user station 52 (e.g., user stations 52A, 52B to 52N). For example, user station 52A, 52B and 52N, each connect to the KVM switch 10 through a separate port (e.g., 14A, 14B and 14N) and each of these ports have separate ports for each keyboard, video and mouse associated with a user station.

The KVM switch 10 includes one or more ports 16 for coupling the KVM switch 10 to one or more host processors 54 (e.g., host processors 54A, 54B to 54N). The ports 16 may be configured with an appropriate connector to facilitate connection with one or more host processors 54. Host processors 54 (e.g., host processors 54A, 54B to 54N) may take a variety of forms, including: a personal or laptop computer running a Microsoft Windows operating system, a PalmOS operating system, a UNIX operating system, a Linux operating system, a Solaris operating system, an OS/2 operating system, a BeOS operating system, a MacOS operating system, a VAX VMS operating system, or other operating system or platform. Host processors 54 may further include a microprocessor such as an Intel x86-based or Advanced Micro Devices x86-compatible device, a Motorola 68K or PowerPC device, a MIPS device, Hewlett-Packard Precision device, or a Digital Equipment Corp Alpha RISC processor, a microcontroller or other general or special purpose device operating under programmed control. Likewise, host processors 54 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons of ordinary skill in the art.

The KVM switch 10 includes switching circuitry 20 (FIG. 1) included within housing 12. The switching circuitry 20 may be selectively operable to facilitate the exchange of signals between one or more user stations and one or more of the host processors through ports 14 and 16, such that a user at one user station (e.g., 52A) may have access to any of the host processors 54 (e.g., 54A, 54B to 54N). This, of course, assumes that the user has appropriate access rights to access such host processors.

As shown in FIG. 2, the KVM system 50 further includes an external device 70 that includes at least one sensor 72 and/or an application program 74 for detecting an occurrence of an event, alarm and/or notification and generates an output signal based on the detected occurrence. As used herein the term “external” means that the device is separate from the KVM switch 10 and the external device communicates with the KVM switch 10 through one or more of input ports 18.

The external device 70 may monitor one or more environmental conditions associated with one or more of the host processors 54. For example, the remote device 70 may include a temperature sensor (e.g., a thermostat) in a server room in which one or more of the host processors are stored. In another embodiment, the remote device 70 may include a contact sensor used to detect when a cabinet door to the server has been opened. One of ordinary skill in the art will readily appreciate that a temperature sensor and a contact sensor are exemplary and that the remote device may include other types of sensors (e.g., fire sensors, smoke sensors, water sensors, gas sensors, humidity sensors, voltage sensors, analog inputs, digital inputs, etc.).

In addition to sensor 72 or in lieu of sensor 72, the remote device may execute an application program 74 that is capable of generating an output signal based upon an event, alarm and/or notification that occurs through software. For example, the application program 74 may be an electronic calendar application that may remind the user of an upcoming appointment. The alarms, event and/or notifications may relate to environmental conditions, maintenance schedules, personal schedules, etc. In another example, the application program 74 may monitor access to restricted host processors and/or user stations and provide a notification that a user has logged onto a restricted host processor and/or user station. One of ordinary skill in the art will readily appreciate that the above embodiments are exemplary and that the remote device may include software applications to generate output signals for other types of events, alarms and/or notifications.

The sensor 72 may be coupled to the external device 70 through a medium 76. The medium 76 may be wired medium, a wireless medium and/or a combination of a wired and wireless medium.

Although shown as separate components, the sensor 72 and the external device 70 may also be combined in a single unit. In one embodiment, the external device 70 may be an environment monitoring system that centrally monitors a plurality of sensors. The sensor 72 may be one or more sensors that are coupled to the external device 70 to detect one or more conditions that are being monitored. The external device 70 may be configured to generate an event, alarm and/or notification upon the occurrence of a detected condition. Such conditions include, for example, temperature warnings, server cabinet door is open, low voltage, high voltage, high humidity, etc.

Upon receipt of the event, alarm and/or notification, the external device 70 may output a signal to the one or more input ports 18 of the KVM switch. The external device 70 may be coupled directly to the KVM switch 10 and/or may be coupled through a network 78 to the input port(s) of the KVM switch 10. The input ports 18 may be any suitable type or types of ports. For example, the input ports 18 may include one or a combination of a serial port, an Ethernet port, a wireless port or any other suitable port for receiving signals from the external device 70. The external device 70 may be coupled by any medium to deliver the generated signal to the KVM switch 10 at input port 18.

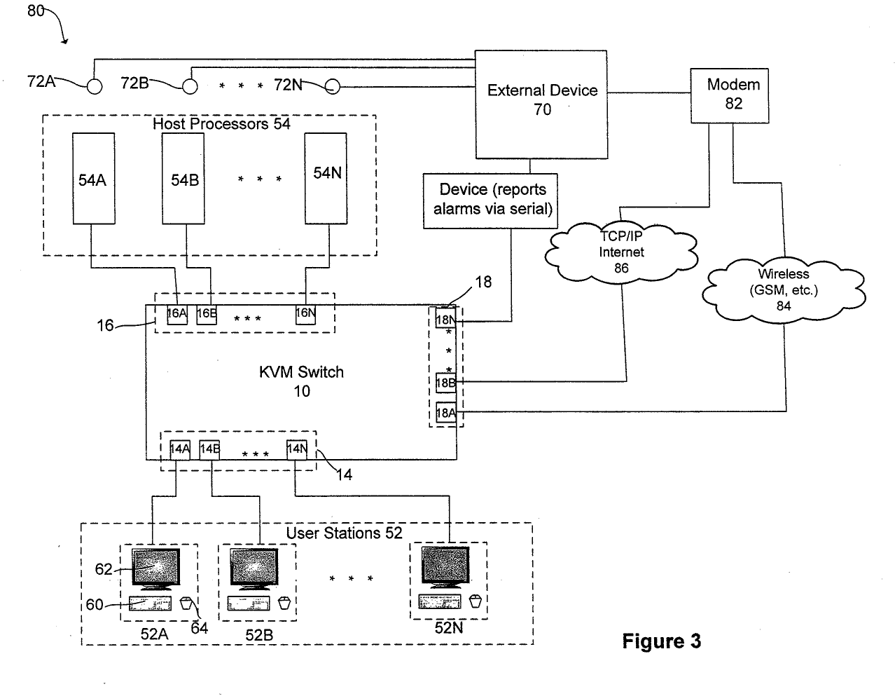

Referring to FIG. 3, an exemplary system 80 is illustrated. In system 80, the external device 70 may be a central monitoring system, such that all sensors (sensors 72A, 72B to 72N) in a given geographic location are coupled to the external device 70. The external device 70 may be configured to generate an event and/or an alarm upon the occurrence of a detected environment condition. Such conditions include, for example, temperature warnings, server cabinet door is open, low voltage, high voltage, high humidity, etc. Upon receipt of the event and/or alarm, the external device 70 outputs a signal to the one or more input ports 18 of the KVM switch. The input ports 18 may be one or a combination of a serial port, an Ethernet port, a wireless port or any other suitable port for receiving signals from the external device 70.

For example, the external device 70 may be coupled to a modem 82. The modem 82 may be any type of modem. In one embodiment, the modem 82 is a GSM modem for facilitating communications over a mobile telephone communication medium. As shown in FIG. 3, the modem 82 may be coupled to a wireless service provider network 84 and be received at the KVM switch 10 through a suitable port 18. For example, the modem may send the signal to be received by a wireless communication port (e.g., port 18A) of the KVM switch 10.

In another embodiment, the external device 70 may be coupled to a TCP/IP Internet network 86 through a wired and/or wireless medium. Signals transmitted from the external device 70 may be received at port 18B, for example, which may be a wired (Ethernet) port and/or port 18A, which may be a wireless communication port. In yet another embodiment, the external device 70 may have a serial output that is coupled to the KVM switch 10 at serial input port 18N, for example. Although the ports 18A, 18B and 18N have been identified as a wireless port, an Ethernet port, and a serial port, respectively, ports 18A, 18B, 18N may take any desired form and may be a combination of port types.

The events, alarms and/or notifications may be triggered by the external device 70 in any manner, including asynchronous signaling, polling a KVM input port for received signals, etc. The events, alarms and/or notifications may also be generated by software that is capable of generating such signals upon the occurrence of an event, alarm or notification. For example, the events, alarms and/or notifications may be generated by one or more software applications, by an electronic calendar application, electronic mail application, monitoring software, maintenance schedules, authentication and auditing applications, etc.

In one embodiment, upon the detection of an event and/or alarm, the external device 70 may transmit a SNMP trap to the KVM switch 10. A SNMP trap enables the external device 70 to notify the KVM switch 10 of the detection of an event and/or an alarm through an unsolicited SNMP message. The KVM switch 10 may incorporate SNMP listeners at the ports 18 to monitor receiving a signal at one of the ports 18A-18N, for example.

In general, the concept behind trap-directed notification is that if a central device (e.g., KVM switch) is responsible for a large number of devices (e.g., sensors 72), it is impractical for the central device to poll or request information from every device. The solution is for each external device 70 to notify the central device without solicitation. The agent may do this by sending a message known as a trap of the event to the central device. The agent is generally configured to send a trap to a network management system. In such cases, the agent generally knows that it should send a trap. The trap destination is usually defined by an IP address, but can be a host name, if the device is set up to query a Domain Name System (DNS) server.

Generally, the SNMP trap includes an object identifier. The object identifier may identify the condition that caused the trap. In order for a KVM switch 10 to understand a trap sent to it, the KVM switch 10 should know what the object identifier defines. Therefore, the KVM switch 10 generally has management information base (MIB) or other suitable reference information for that trap available in memory (e.g., internal or memory 24).

When the KVM switch 10 receives the SNMP trap, the control circuitry 22 may process the received trap to determine the object identifier contained in the trap. The control circuitry may then compare the received identifier to one or more reference identifiers or signals stored in the memory of the KVM switch to identify an event that corresponds to the received external signal. The control circuitry 22 may then generate an announcement for display on the one or more video monitors associated with one or more user stations.

The announcement may be displayed in a separate menu that overlays all or a portion of the content displayed on the video displays of one or more user stations. In another embodiment, the announcement may be embedded in the content of the display, preferably in a conspicuous manner. In yet another embodiment, it may be desirable for the announcement to include an audio and/or graphic feature that draws the user's attention to the announcement on the video monitor that the user is using.

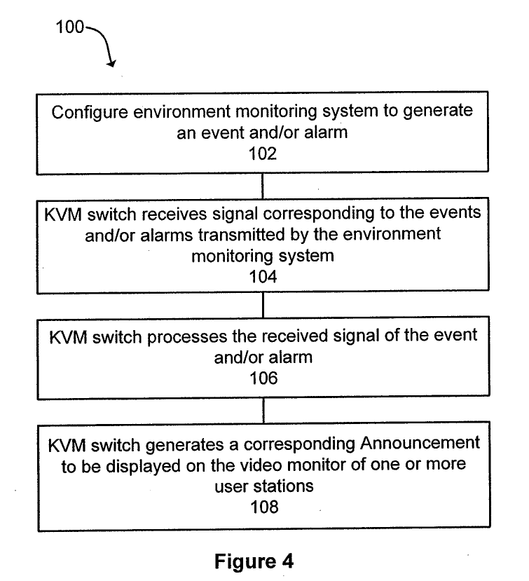

An exemplary method 100 in accordance with aspects of the present invention is illustrated in FIG. 4. At block 102, an external device 70 is configured to generate an event, alarm and/or notification. The external device 70 generates the event and/or alarm when a sensor 72 is coupled to the external device or part of the external device senses a condition that is being monitored and generates an event, alarm and/or notification. Such a condition may include an open cabinet door on a host processor and/or server, temperature warnings, low voltage, high voltage, high humidity, etc. In addition to environmental conditions, conditions may also include software generated events, alarms and/or notifications. For example, the events, alarms and/or notifications may be generated by one or more software applications, by an electronic calendar application, an electronic mail application, monitoring software, maintenance schedules, authentication and auditing applications, etc.

The sensors 72 may also be configured to communicate such events and/or alarms to the KVM switch, if the sensors are configured to generate the event and/or alarm.

At block 104, KVM switch 10 receives one or more signals corresponding to the events and/or alarms transmitted by the external device 70 and/or by the sensor(s) 72.

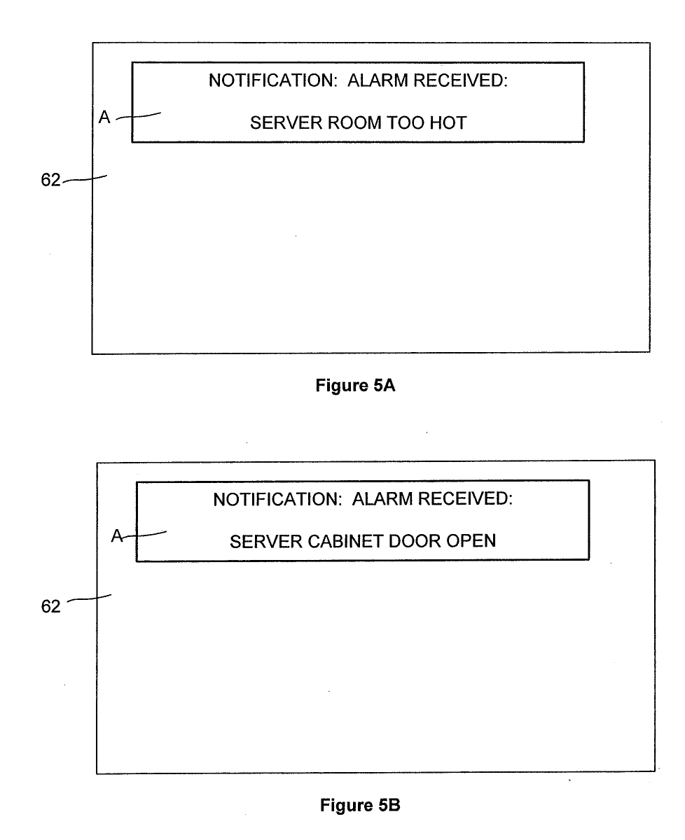

At block 106, the KVM switch 10 processes the received event and/or alarm signal and, at block 108 generates a corresponding announcement to be displayed on the video display of one or more user stations. An exemplary announcement (A) presented on the video monitor 62 of one or more user stations is illustrated in FIGS. 5A and 5B. The announcement (A) may be displayed on all screens coupled to the KVM switch 10 and/or may only be displayed screens in which the user has appropriate administrative rights. In such a case, users having low level rights will not be notified upon the occurrence of an event, but users having appropriate administrative rights will be notified by an announcement displayed on the video screen of their user station.

The announcement (A) may take a variety of forms including text, graphical, and/or a combination of textual and graphical. For example, the announcement may include textual information contained within a menu displayed on a video monitor of one or more user stations, as shown in FIGS. 5A and 5B. In addition, the announcement (A) may also include an audible component that may be output a speaker (not shown) of one or more of the user stations. In another embodiment, the announcement (A) may also include a conspicuous graphical element displayed within the content of the user's display. Such announcement will generally be provided with graphical effects to draw the user's attention to the announcement.

By incorporating alarm receiver functionality into KVM switch 10, a more efficient, dependable and reliable delivery of alarms is provided to users of KVM switch 10. For example, the following are advantages of the KVM alarm display method disclosed herein over standard methods: (1) a user may be connected to any host processor on the KVM switch 10 and not worry about missing a critical alarm message since alarm notifications can be broadcast to all connected displays and/or tailored to particular users; (2) other than SMS messages, most other traditional notification methods require the user to be connected to a specific host processor, which is running special network management software, to be alerted of or see the alarm; (3) extra network management software, which is typically operating system dependent, is not required to receive the alarms; and (4) the user may be connected to any type of host processor (e.g., SUN, Linux, UNIX, Windows, Mac, serial device, etc) and still receive the alarms since the methods described herein are not tied to any specific operating system or software.

The foregoing is an exemplary use case in accordance with aspects of the present invention. A temperature sensor is provided in a server room to monitor the conditions of the server room. A contact sensor used to detect when the server cabinet door has been opened is also provided on the server cabinet. Both of these sensors may be connected to an external device capable of reading their values and generating alarms when certain events occur. Such an external device may be configured to send SNMP traps when the temperature in the server room crosses a threshold or when the server cabinet door is opened, for example.

The KVM switch 10 is configured to listen for these SNMP traps. Upon receipt of a known event, alarm and/or notification, the KVM switch 10 decodes the alarm and generates an appropriate announcement to be displayed on the screen of one or more or user stations 52. The announcement may be displayed on all screens coupled to the KVM switch 10 and/or may only be displayed screens in which the user has appropriate administrative rights.

One of ordinary skill in the art will appreciate that the above example is illustrative in nature. The alarms, events and/or notifications may be generated through hardware and/or software. The alarms, event and/or notifications may relate to environmental conditions, maintenance schedules, access to particular host processors and/or user stations, personal schedules and/or calendar information from an electronic calendar application, etc.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time. It should be further noted that although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A keyboard, video and mouse (KVM) switch, the KVM switch comprising:
a housing;
switching circuitry contained at least partially within the housing, wherein the switching circuitry is selectively operable to couple one or more user stations to one or more host processors;
a plurality of user station ports for communicatively coupling one or more user stations to the switching circuitry, wherein at least one user station includes a keyboard port for coupling to an associated keyboard, a video display port for coupling to an associated video display and a mouse port for coupling to an associated mouse;
a plurality of host processor ports for communicatively coupling one or more host processors to the switching circuitry;
one or more input ports for receiving an external signal from an associated device;
a controller housed at least partially within the housing, wherein the controller is coupled to the switching circuitry and at least one of the input ports, wherein the controller processes the received external signal received at the one or more input ports and compares the received external signal to one or more reference signals to identify an event that corresponds to the received external signal and the controller generates an announcement for display on one or more of the displays associated with one or more user stations.

2. The KVM switch of claim 1, wherein the one or more input ports for receiving the external signal includes a serial port.

3. The KVM switch of claim 1, wherein the one or more input ports for receiving the external signal is a wireless interface adapter for exchanging information with a remote device wirelessly.

4. The KVM switch of claim 1, wherein the one or more input ports for receiving the external signal is an Ethernet port capable of exchanging information with a remote device through TCP/IP protocol.

5. The KVM switch of claim 1, wherein a plurality of the user station ports include a keyboard port, a video display port and a mouse port.

6. The KVM switch of claim 1 further including a memory for storing the one or more reference signals.

7. A method of providing an announcement of an occurrence of an environmental event associated with one or more components of a keyboard, video and mouse (KVM) system to users of the KVM system, the method comprising:
receiving an external signal from an associated device at a KVM switch;
comparing the received external signal to one or more reference signals stored in a memory coupled to the KVM switch to identify an event that corresponds to the received external signal at the KVM switch;
generating an announcement that corresponds to the received external signal, and
displaying the announcement on one or more displays coupled to the KVM switch.

8. The method of claim 7, wherein the external signal is a serial signal received by a serial port of the KVM switch.

9. The method of claim 8, wherein the KVM switch periodically polls the serial port to determine presence of the external signal.

10. The method of claim 7, wherein the external signal is a wireless signal received by a wireless adapter coupled to the KVM switch.

11. The method of claim 10, wherein the external signal is in the form of a simple network management protocol (SNMP) trap signal that is transmitted from the associated device through a modem.

12. The method of claim 11, wherein the KVM switch includes a trap listener that monitors signals received by the wireless adapter to determine presence of the received external signal at the KVM switch.

13. The method of claim 10, wherein the external signal is a short message service (SMS) transmitted from the environmental monitoring device through a modem and received at the KVM switch.

14. The method of claim 7, wherein the external signal is an asynchronous signal generated by the associated device and received at the KVM switch.

15. The method of claim 7, wherein the associated device is an environmental monitoring device that monitors at least one of the following events: an actual temperature detected at near one or more host computers coupled to the KVM system above a threshold temperature and/or a cabinet door that houses one or more of the host computers in an ajar state.

16. The method of claim 7, wherein the associated device is an electronic device that generates the external signal through software.

17. The method of claim 7, wherein the announcement is displayed only on displays coupled to the KVM switch, wherein an associated user logged onto the display is authorized to receive the announcement.

18. A system for providing on-screen announcements to users of a keyboard, video and mouse (KVM) system upon the occurrence of an event, notification and/or alarm, the system comprising:
an external device for generating an output signal upon an occurrence of an event;
a KVM switch having a plurality of ports for coupling one or more user stations to one or more host computers, wherein the KVM switch includes a one or more input ports for receiving the output signal generated from the external device, wherein the KVM switch includes a controller that processes the received output signal from the external device and compares the received output signal to one or more reference signals to identify an event that corresponds to the received external signal and the controller generates an announcement for display on a display associated with one or more user stations.

19. The system of claim 18, wherein the external device includes a sensor that outputs the output signal upon the occurrence of at least one of the following events: an actual temperature detected at near one or more host computers coupled to the KVM system above a threshold temperature and/or a cabinet door that houses one or more of the host computers in an ajar state.

20. The system of claim 18, wherein the external device generates the output signal upon the occurrence of a software generated event.
